(19) United States
(12) Patent Application Publication
(10) Pub. No.: US 2015/0117039 A1
(43) Pub. Date: Apr. 30, 2015

(54) Substrate Gap Mounted LED

(71) Applicant: Kevin Yang, Lomita, CA (US)

(72) Inventor: Kevin Yang, Lomita, CA (US)

(21) Appl. No.: 14/063,933

(22) Filed: Oct. 25, 2013

(51) Int. Cl. F21V 19/00

(52) U.S. Cl. CPC F21V 19/0025; F21V 19/003
USPC 362/382

(57) ABSTRACT

A substrate gap mounted LED light includes an LED chip having an LED chip first terminal and an LED chip second terminal. A plurality of substrates have a metal construction, and the plurality of substrates includes a first substrate and a second substrate. A frame retains the plurality of substrates. A substrate gap is formed between the first substrate and the second substrate. The first substrate is not touching the second substrate. An LED chip first terminal is formed on the LED chip, and an LED chip second terminal is formed on the LED chip. The LED chip first terminal is mounted to the first substrate, and the LED chip second terminal is mounted to the second substrate. The LED chip is mounted across the substrate gap.

This application is a continuation in part of U.S. patent application Ser. No. 13/963,496 filed Aug. 9, 2013 entitled edge mounted LED, the disclosure of which is incorporated herein by reference.

### FIELD OF THE INVENTION

The present invention is in the field of LED lights.

### DISCUSSION OF RELATED ART

Traditionally, light emitting diodes (LEDs) have been mounted to circuit boards which are then mounted to heatsinks. Heat sinks typically include a variety of different fin configurations. LED lights have also been mounted to an edge of a circuit board. The LED light is becoming more popular recently because of its longevity and long duty cycle. Heat dissipation remains one of the most pressing challenges to LED light innovation. As a result, many designs have been created for various heat dissipation strategies.

Recently, LEDs have been mounted directly to heat dissipation substrates using the chips on board (COB) mounting configuration. The COB configuration can be further improved. Joo et al, U.S. Pat. No. 8,168,997, published May 1, 2012, entitled Light Emitting Diode Package is disclosed herein by reference. Joo teaches about and LED package in which conductive structures formed of silicone are mounted on a printed circuit board (PCB), instead of electrode pads formed of silver (Au) or gold (Ag), which would reduce manufacturing cost. However, the reduction of manufacturing cost through the use of silicone increases the temperature of LED units and related areas, because of silicone's low thermal conductivity. Orsley et al, US2013/0175558, published on Jul. 11, 2013, entitled LED Lighting Devices is disclosed herein by reference. Orsley proposes an alternative, where a packaged COB LED array where a color conversion medium is distributed within a glass containment plate, rather than silicone, to reduce the operating temperature of the color conversion medium and avoid damage while increasing light output.

Another concern of LEDs is the amount of light output. Jung et al., U.S. Pat. No. 8,183,583, published May 22, 2012, entitled LED Package module, is disclosed herein by reference addresses this concern. Jung describes a substrate having predetermined electrodes thereon; a plurality of LED chips mounted onto the substrate, separated from each other at predetermined intervals, and electrically connected to the electrodes. A first, second, and third color resin that each consist of a different color encompass the LED in a different way, enabling an increase in luminous efficiency and reduction in size.

### SUMMARY OF THE INVENTION

A substrate gap mounted LED light includes an LED chip having an LED chip first terminal and an LED chip second terminal. A plurality of substrates have a metal construction, and the plurality of substrates includes a first substrate and a second substrate. A frame retains the plurality of substrates. A substrate gap is formed between the first substrate and the second substrate. The first substrate is not touching the second substrate. An LED chip first terminal is formed on the LED chip, and an LED chip second terminal is formed on the LED chip. The LED chip first terminal is mounted to the first substrate, and the LED chip second terminal is mounted to the second substrate. The LED chip is mounted across the substrate gap.

The substrate gap mounted LED light preferably includes a ridge formed on the frame. The ridge protrudes into the gap between the first substrate and the second substrate. The first substrate is oriented parallel to the second substrate. The substrate gap mounted LED light also has a third substrate strip and a fourth substrate strip. The third substrate strip is parallel to the fourth substrate strip. A first slot can be formed on the frame. The slot receives the first substrate. A second slot can be formed on the frame. The second slot receives the second substrate. The substrate gap mounted LED light further includes a perpendicular substrate strip that is both mounted to be perpendicular to the first substrate and mounted to be perpendicular to the second substrate. The first substrate is formed as a first substrate strip, and wherein the second substrate is formed as a second substrate strip. The first substrate strip and the other substrate strips are preferably made of copper clad aluminum.

The substrate strips can also be anodized aluminum. An airflow hole can be formed on the first substrate strip or on some or all of the substrate strips.

### BRIEF DESCRIPTION OF THE DRAWINGS

FIG. 1 is a side view of the substrate gap mounted LED light assembly.

FIG. 2 is a perspective view of the substrate gap mounted LED light assembly.

FIG. 3 is a perspective exploded view of the present invention showing assembly of the LED light assembly.

FIG. 4 is a top view of the frame.

FIG. 5 is a side view of the frame.

FIG. 6 is a bottom view of the frame.

FIG. 7 is a partial cross-section view of the frame.

FIG. 8 is an underside view of the LED chip.

FIG. 9 is a circuit diagram of the present invention.

FIG. 10 is a perspective view showing mounting of the input terminal on the supplemental substrate strip.

FIG. 11 is an exploded view diagram of the present invention.

FIG. 12 is a perspective diagram of the present invention.

FIG. 13 is a side view diagram of the present invention.

The following call out list of elements can be a useful guide in referencing the element numbers of the drawings.
20 Frame
21 Rear Frame Wall
22 Side Frame Wall
23 Slot
24 Front Frame Wall
25 Frame Opening
26 Divider Ridge
27 Frame Mounting Openings
30 Substrate
31 First Substrate Strip
32 Second Substrate Strip
33 Third Substrate Strip
34 Fourth Substrate Strip
35 Fifth Substrate Strip
36 Sixth Substrate Strip
37 Substrate Mounting Openings
38 Seventh Substrate Strip
40 LED Chip
41 First Chip Row
42 Second Chip Row
43 Third Chip Row
44 Fourth Chip Row
45 Fifth Chip Row
46 Supplemental Element
47 First LED Chip Polarity Terminal
48 Second LED Chip Polarity Terminal
50 Connector
51 First Screw Connector Row
52 Second Screw Connector Row
53 Third Screw Connector Row
54 Fourth Screw Connector Row
55 Fifth Screw Connector Row
56 Sixth Screw Connector Row
57 Seventh Screw Connector Row
81 Input Terminal
82 Air Flow Hole
88 Substrate Gap
89 Chip Substrate Gap

### DETAILED DESCRIPTION OF THE PREFERRED EMBODIMENT

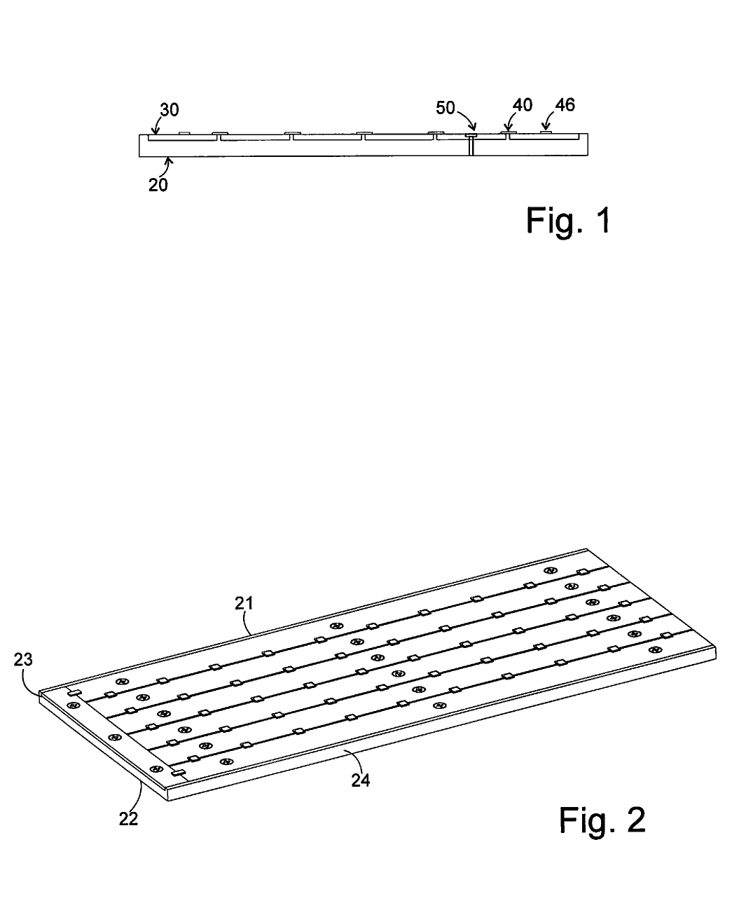

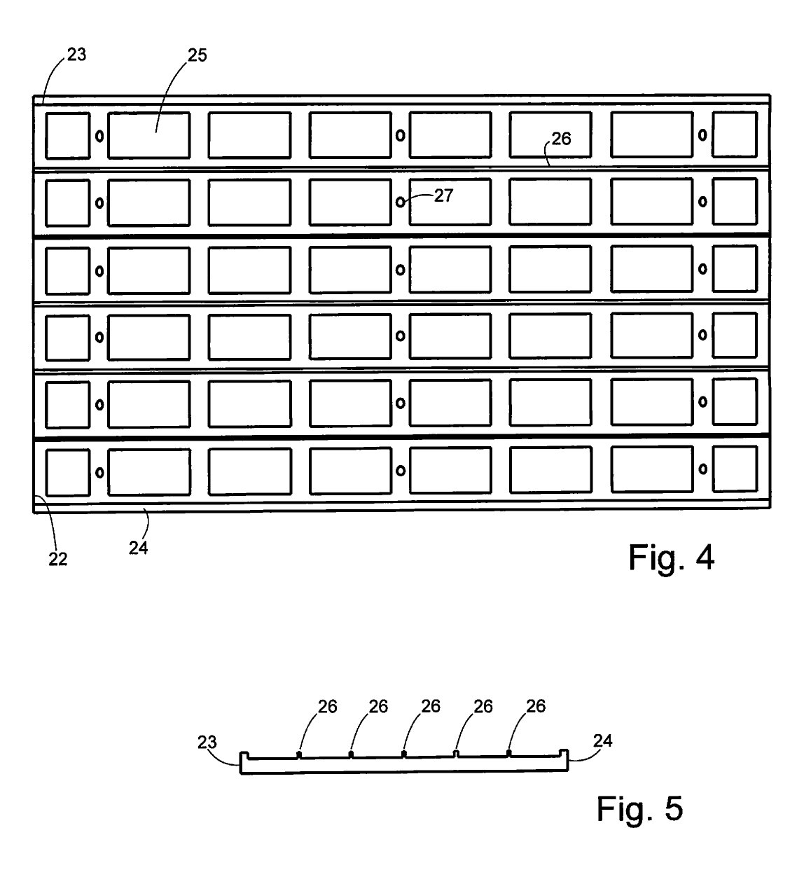

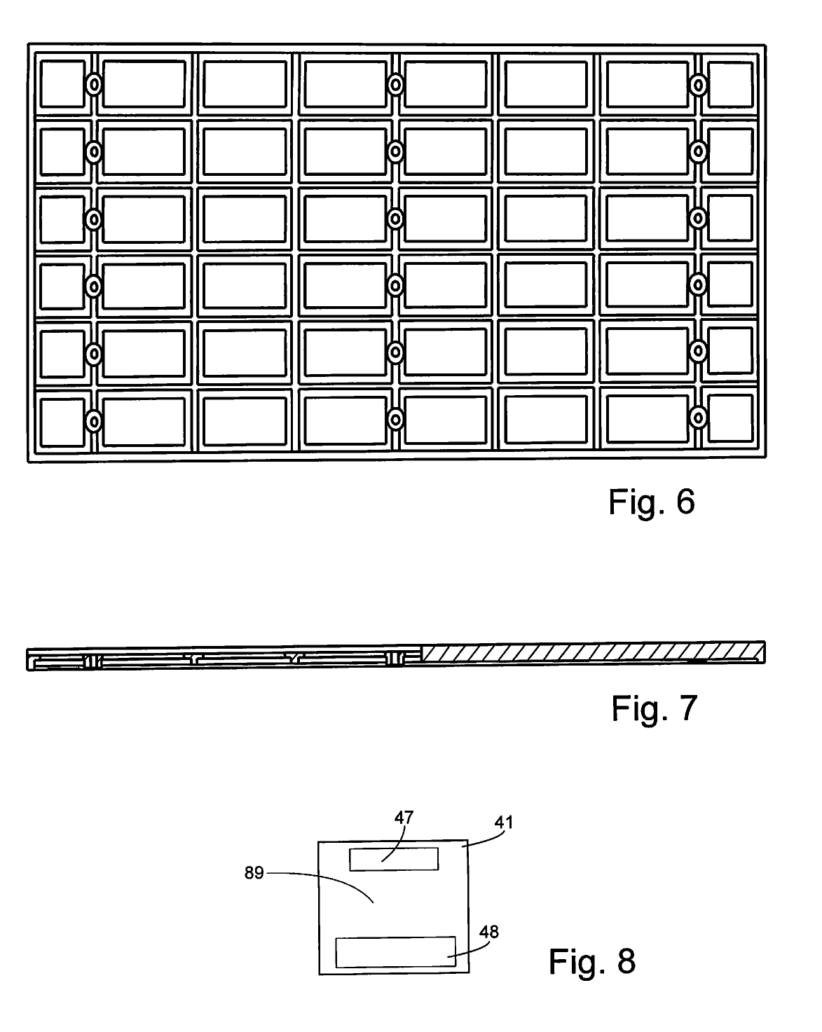

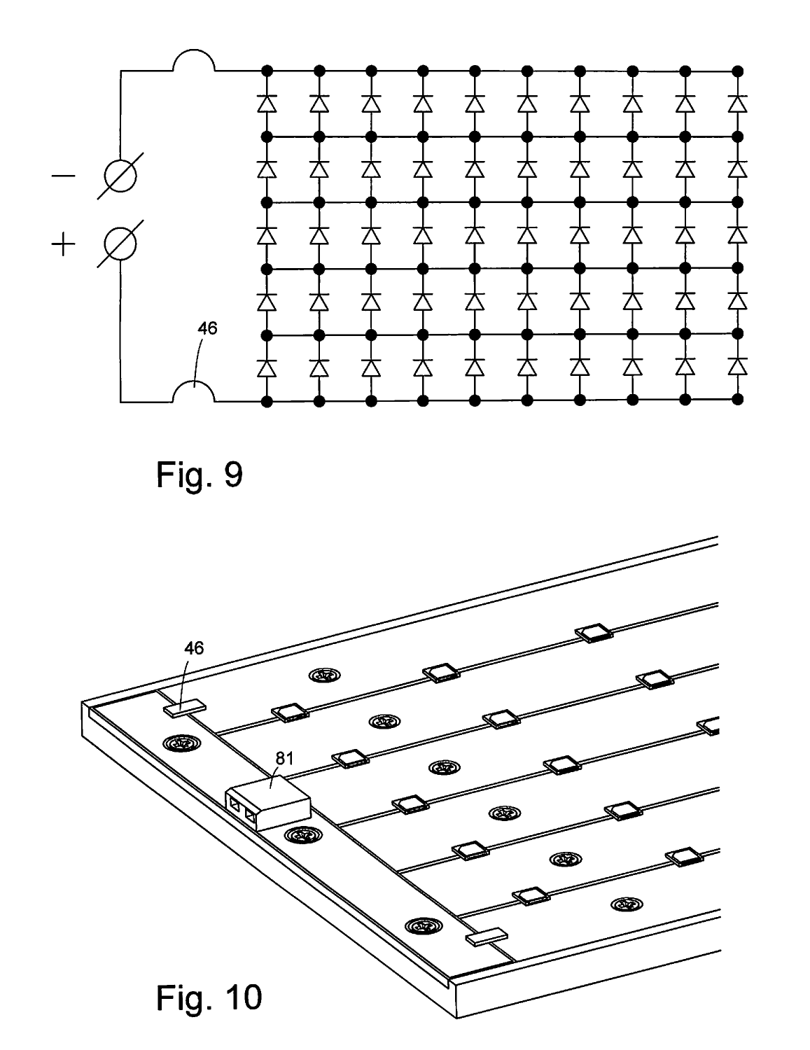

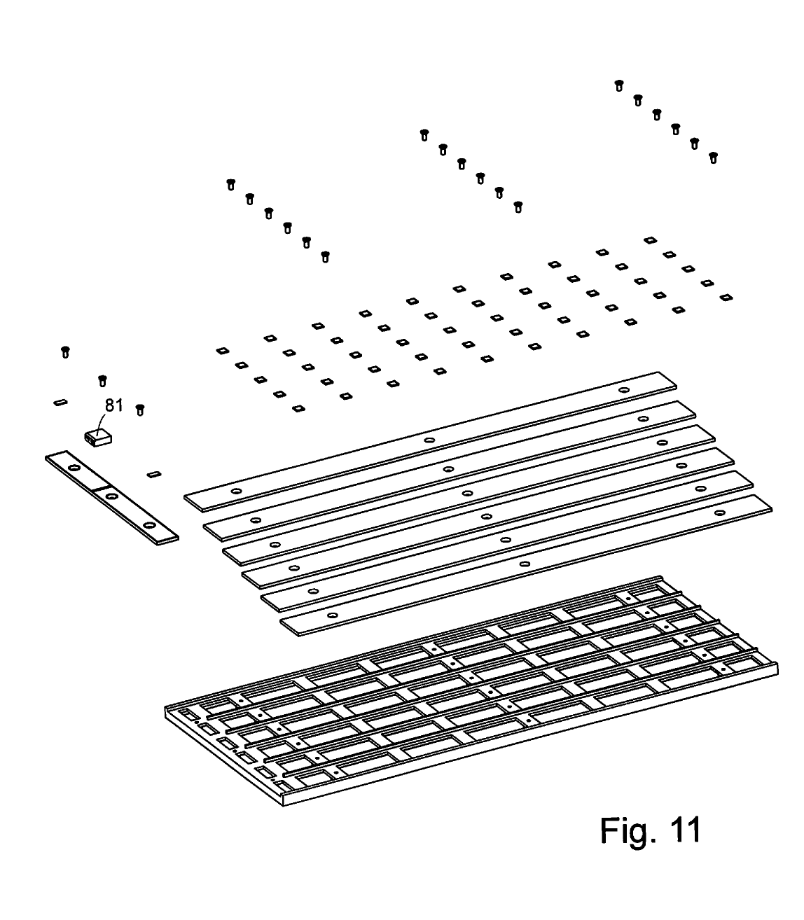

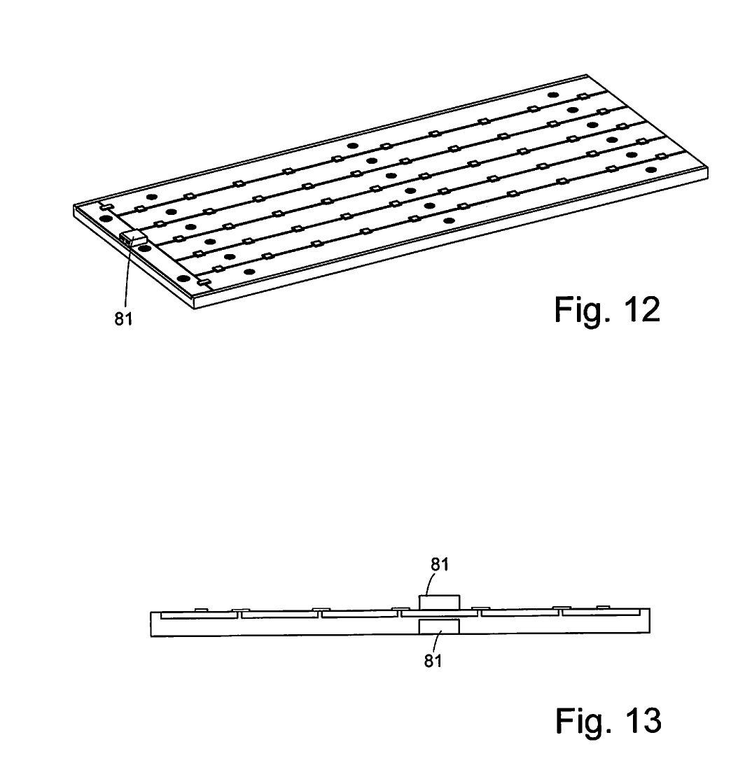

FIGS. 1-8 show construction and assembly procedures of a frame. FIGS. 9-13 show assembly of a supplemental substrate strip perpendicular to the other substrate strips as well as showing the assembly of the input terminal to the supplemental substrate strip.

Substrate conduction layers receive a plurality of LED chips along their face edges. A pair of substrates can be formed as aluminum strips having a thickness of 1 mm. The LED can be mounted between the pair of conduction members. Mounting the substrate conduction members 30 to a frame 20 allows a number of aluminum strips to be retained and present a flat surface. On the flat surface, the LED chips 40 are mounted directly to the aluminum strips. The aluminum strips are connected to the frame 20 by connectors 50 such as screws or bolts, but the connectors can also be clips.

The frame 20 generally includes a rear frame wall 21 and a front frame wall 24. The side frame wall 22 has multiple slots 23 for receiving aluminum strips. The aluminum strips are substrates which are mounted with a gap between the aluminum strips. The side frame wall 22 has a slot to allow insertion of the substrates into the frame. The frame also has a number of rectangular frame openings 25 that allow airflow to cool the substrate. The frame openings 25 are formed as an array with multiple columns and multiple rows.

At least one divider ridge 26 is formed on the frame 20. Multiple divider ridges can be formed to size a gap between the aluminum strip substrates 30. Frame mounting openings 27 are formed as an array to receive connectors 50 for maintaining physical connection between the frame and the substrates. The frame 20 is preferably made of an injection molded nonconductive plastic or a material such as fiberglass nylon composite. The frame 20 may further include mounting holes for mounting to a housing, cover or reflector.

The substrates 30 are preferably copper clad aluminum, copper clad steel or can be made of any comparable material such as solid copper. The substrates 30 receive the LED chips 40 directly to the substrates. The LED chips 40 have a first LED chip polarity terminal 47 and a second LED chip polarity 48 terminal. The first terminal and the second terminal can be the anode and the cathode.

The substrate strips 30 can be aligned in rows. For example, a first substrate strip 31 can be parallel to a second substrate strip 32. The second substrate strip 32 can be parallel to a third substrate strip 33. The third substrate strip 33 can be parallel to a fourth substrate strip 34. The fourth substrate strip 34 can be parallel to a fifth substrate strip 35. The fifth substrate strip 35 can be parallel to a sixth substrate strip 36. The substrate strips have substrate mounting openings 37 for receiving a connector mounting to the frame. A substrate strip such as the seventh substrate strip 38 can be parallel to the other substrate strips.

LED chips are mounted between the substrates on the substrate gap 88. The substrate gap mounted LEDs may be mounted in rows. For example, a first chip row 41 can be mounted between the first substrate strip and the second substrate strip. A second chip row 42 can be mounted between the second substrate strip and the third substrate strip. A third chip row 43 can be mounted between the third substrate strip and the fourth substrate strip. A fourth chip row 44 can be mounted between the fourth substrate strip and the fifth substrate strip. A fifth chip row 45 can be mounted between the fifth substrate strip and the sixth substrate strip. Alternatively, the LED chips can be mounted in rows that are perpendicular to each other. For example, supplemental elements 46 can be mounted in a row that is perpendicular to the first chip row, 41, the second chip row 42, the third chip row 43, the fourth chip row 44, and the fifth chip row 45. The supplemental elements 46 could be made as LEDs but are preferably simple electrical connectors. When the supplemental elements 46 are made as LEDs, they are supplemental LED chips. The supplemental elements 46 can also have additional circuitry function such as frequency filtering, power control, processor or wireless communications. The supplemental elements 46 can also be simple electrical connectors.

An input terminal can have a pair of contacts for connecting to the LED terminals which are the anodes and cathodes of the LEDs. The rows of LEDs are in series to each other while each LED in a row is in parallel with other LEDs in the same row. FIG. 9 shows that supplemental elements 46 are simple electrical connectors. In contrast with the other substrate strips, the supplemental substrate strip can be a printed circuit board. When the supplemental elements 46 are made as simple electrical connectors, such as wire jumpers or flat metal plates, the supplemental substrate is preferably a PCB board. The PCB board can be connected to the frame, or connected to a supplemental frame that is fused to the frame. The PCB board can also be inverted so that the components are on the underside of the PCB board. Alternatively, the input terminal can be formed to be flush with the side frame wall 22 as seen in FIG. 13.

The connectors 50 follow a similar pattern. The first screw connector row 51 connects the first substrate to the frame. The second screw connector row 52 connects the second substrate to the frame. The third screw connector row 53 connects the third substrate to the frame. The fourth screw connector row 54 connects the fourth substrate to the frame. The fifth screw connector row 55 the next the fifth substrate to the frame. The sixth screw connector row 56 connects the sixth substrate to the frame. The seventh screw connector row 57 connects the seventh substrate to the frame.

LED chips have a pair of terminals. A first terminal is connected to a first polarity and a second terminal is connected to a second polarity. As seen in FIG. 9, the polarity are preferably aligned such that all of the first polarity terminals are facing one direction. The first terminal and second terminal being the anode and cathode are preferably of opposing orientation located on a bottom surface of the surface mounted LED chip (SMD LED).

The preferred diagram is to have low-voltage to high-voltage on the array shown in FIG. 9. Alternatively, the first polarity 47 could alternate with the second polarity 48. If the first polarity 47 is negative, and the second polarity 48 is positive, the first substrate 31 would have a negative polarity. The second substrate 32 would have a positive polarity. The third substrate 33 would have a negative polarity. The fourth substrate 34 would have a positive polarity. The fifth substrate 35 would have a negative polarity. The sixth substrate 36 would have a positive polarity. The seventh substrate 38 might have a positive or negative polarity. The seventh substrate strip 38 can be perpendicular to the first substrate and the second substrate. Alternating polarity is not preferred because it leads to a lower voltage and therefore lower efficiency. It is preferred to have each row in series with the next row to raise the voltage as seen in FIG. 9. For example, if each row is 3V, the entire sum of the five rows would be a total of 15 V.

The substrate is preferably a conduction sheet formed as strips of metal, such as steel. The conduction sheets are both preferably extruded flat metal bars, or rolled flat metal bars but can also be made from sheets of metal. The metal bars are preferably of rectangular cross-section and having high thermal conductivity. The conduction sheets may have coatings applied on a surface of the conduction sheets to limit corrosion. The conduction sheets may have sacrificial anode attachments for inhibiting corrosion.

The LED light is printed circuit board free. The LED light has direct mounting meaning that the LED chip is soldered directly to the heatsink and does not have a circuit board substrate. Electricity is supplied to the LED light through the heatsink. Replacement of a faulty or burned out portion can be done by hand. The best mode of the present invention is to avoid having a circuit board substrate that the LED chip must be first mounted to. The LED chip should be mounted directly to the conductive heatsink. The conductive heat sinks have differing electrical polarity to provide electrical power to the LED chip.

Resin can be applied to an underside of the frame so as to glue the substrate to the frame. Solder paste can connect the terminals on the underside of the LED chip to the substrates. A terminal gap on the LED chip does not short due to the substrate gap. The first terminal 47 and second terminal 48 have a chip substrate gap 89 between them.

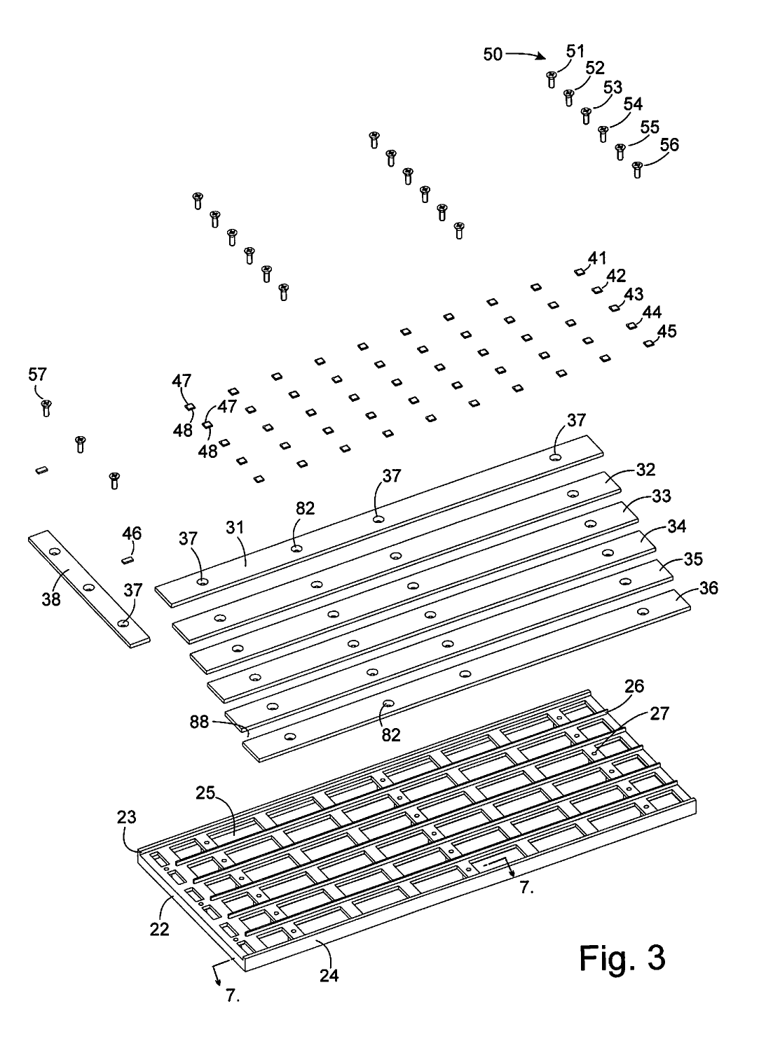

An airflow hole 82, as seen in FIG. 3, or a plurality of airflow holes can be formed on the first substrate strip 31, or on all of the substrate strips. The airflow hole 82 is aligned with the frame opening for airflow optimization. A fan can improve airflow with forced convection, and natural convection is also preferable.

The following detailed description of the preferred embodiment describes a preferred embodiment of the present invention. The invention will now be defined by the claims below.

1. A substrate gap mounted LED light comprising:
a. an LED chip having an LED chip first terminal and an LED chip second terminal;
b. a plurality of substrates having a metal construction, wherein the plurality of substrates includes a first substrate and a second substrate;
c. a frame retaining the plurality of substrates;
d. a substrate gap formed between the first substrate and the second substrate, wherein the first substrate is not touching the second substrate;
e. an LED chip first terminal formed on the LED chip, and an LED chip second terminal formed on the LED chip, wherein the LED chip first terminal is mounted to the first substrate, wherein the LED chip second terminal is mounted to the second substrate, wherein the LED chip is mounted across the substrate gap.

2. The substrate gap mounted LED light of claim 1, further comprising: a ridge formed on the frame, wherein the ridge protrudes into the gap between the first substrate and the second substrate.

3. The substrate gap mounted LED light of claim 1, wherein the first substrate is oriented parallel to the second substrate.

4. The substrate gap mounted LED light of claim 1, further comprising a third substrate strip and a fourth substrate strip, wherein the third substrate strip is parallel to the fourth substrate strip.

5. The substrate gap mounted LED light of claim 1, further comprising a first slot formed on the frame, wherein the slot receives the first substrate, and further comprising a second slot formed on the frame, wherein the second slot receives the second substrate.

6. The substrate gap mounted LED light of claim 1, further comprising a perpendicular substrate strip that is both mounted to be perpendicular to the first substrate and mounted to be perpendicular to the second substrate.

7. The substrate gap mounted LED light of claim 1, wherein the first substrate is formed as a first substrate strip, and wherein the second substrate is formed as a second substrate strip.

8. The substrate gap mounted LED light of claim 7, further comprising: a ridge formed on the frame, wherein the ridge protrudes into the gap between the first substrate and the second substrate.

9. The substrate gap mounted LED light of claim 7, wherein the first substrate strip is parallel to the second substrate strip.

10. The substrate gap mounted LED light of claim 7, further comprising a third substrate strip and a fourth substrate strip, wherein the third substrate strip is parallel to the fourth substrate strip.

11. The substrate gap mounted LED light of claim 7, further comprising a first slot formed on the frame, wherein the slot receives the first substrate strip, and further comprising a second slot formed on the frame, wherein the second slot receives the second substrate strip.

12. The substrate gap mounted LED light of claim 7, further comprising a perpendicular substrate strip that is both mounted to be perpendicular to the first substrate strip and mounted to be perpendicular to the second substrate strip.

13. The substrate gap mounted LED light of claim 12, further comprising: a ridge formed on the frame, wherein the ridge protrudes into the gap between the first substrate and the second substrate.

14. The substrate gap mounted LED light of claim 12, wherein the first substrate strip is parallel to the second substrate strip.

15. The substrate gap mounted LED light of claim 12, further comprising a third substrate strip and a fourth substrate strip, wherein the third substrate strip is parallel to the fourth substrate strip.

16. The substrate gap mounted LED light of claim 12, further comprising a first slot formed on the frame, wherein the slot receives the first substrate strip, and further comprising a second slot formed on the frame, wherein the second slot receives the second substrate strip.

17. The substrate gap mounted LED light of claim 12, wherein the first substrate strip is made of copper clad aluminum.

18. The substrate gap mounted LED light of claim 12, further comprising an airflow hole formed on the first substrate strip.
